(19) United States
(12) Patent Application Publication
(10) Pub. No.: US 2011/0297102 A1
(43) Pub. Date: Dec. 8, 2011

(54) GROOMING TOOL AND METHOD FOR GROOMING AN ANIMAL

(75) Inventor: Yeuh Yu Wang, Kwun Tong (HK)

(73) Assignee: TOPET INTERNATIONAL CO., LIMITED, Kwun Tong (HK)

(21) Appl. No.: 12/793,316

(22) Filed: Jun. 3, 2010

(51) Int. Cl. A01K 13/00

(52) U.S. Cl. 119/631; 119/633

(57) ABSTRACT

A tool for use in grooming an animal. The tool includes a handle with a gripping portion that is pivotable and lockable into a plurality of fixed angular positions relative to a shedding blade that is configured as a loop and is attached to a distal end of the handle. In one variation, the gripping portion may be pivoted to a variety of positions, including to a position within the loop to facilitate transport and storage. The ability to adjust the angular position of the gripping portion may also facilitate the grooming of an animal by the groomer.

### FIELD OF THE INVENTION

The present invention relates to a grooming tool for use in grooming an animal, such as a dog. In particular, the invention is directed to a grooming tool including a handle having a gripping portion that is pivotable into a plurality of fixed angular positions relative to a shedding blade disposed at an end of the handle.

### BACKGROUND OF THE INVENTION

Grooming an animal is important to the animal's health and appearance and can also provide enjoyment to the groomer, which in many cases is the owner of the animal. In this regard, grooming may also allow for bonding between the animal and groomer.

Some animals have a coat of fur that may include an undercoat and a topcoat. For example, many breeds of dogs have a coat comprising a topcoat as well as an undercoat. Generally, the topcoat includes rough, somewhat weather resistant fur. In this regard, the topcoat may function to repel water, wind, and other dirt or debris. The undercoat usually comprises a thick, warm, down-like fur. The undercoat generally includes shorter hairs compared to the topcoat. The undercoat hairs are usually dense enough to resist penetration of water to the skin of the animal and provide an insulating layer in order to assist in keeping the animal warm. As such, many animals, and particularly dogs, seasonally grow a dense undercoat. In turn, the undercoat is also seasonally shed.

Shedding occurs because each follicle of hair in an animal's coat follows a cycle of growing, dying, and thereafter being replaced by another follicle. When the follicle dies, the hair becomes detached or shed. This shedding process may occur constantly. The rate at which fur is shed may be affected by such factors as the breed, age and environment of the animal. For instance, as stated above, the undercoat of the animal may change seasonally, such that in the cooler months of the year the undercoat becomes denser in order to provide warmth and insulation. Accordingly, during warmer months, a portion of the undercoat may be shed.

While shedding of the undercoat occurs naturally, it may be advantageous to assist in the removal of the undercoat by an owner or groomer. For instance, in the case of a dog kept indoors, the owner may wish to assist or accelerate the shedding process by brushing or grooming the dog. The selective grooming of a dog to remove the undercoat may be undertaken in a controlled environment to prevent continuous shedding within the owner's home. Shedding can thus be controlled such that the owner may be able to selectively shed the dog in order to prevent the undercoat from being shed indoors.

Preventing an animal from shedding indoors presents several advantages versus allowing natural shedding. For many individuals the shed fur of the animal may cause allergic reactions. Limiting the amount of fur shed indoors may prevent unwanted allergy symptoms. Further, the fur may cling to upholstery or clothing. This may require much time and effort be dedicated to removing the unwanted hair from such surfaces.

Additionally, assisting in the normal process of shedding through grooming may benefit the health and comfort of the animal. An excessive amount of residual undercoat may cause the animal to endure heat stress more readily due to the insulating properties of the undercoat. Moreover, such grooming and undercoat removal may prevent the animal's fur from becoming tangled or matted. Grooming may also calm or relax the animal.

In this regard, there exists a need to provide tools that assist the owner in the grooming of an animal to remove the undercoat and prevent the unwanted or annoying and uncontrolled shedding of the animal in undesirable circumstances.

### SUMMARY OF THE INVENTION

It has been discovered that traditional grooming tools including shedding blades do not allow owners and other users to achieve optimum angles between the shedding blade and the body of an animal while the user is grooming an animal. As the shedding blade on traditional grooming tools is rigidly fixed to the handle at a predetermined angle, it has now been recognized that many portions of the animal are difficult to because of the awkward manner in which the user must grip the handle in an attempt to ensure flush contact between most or all of the shedding blade and the body of the animal with sufficient pressure particularly for shedding blades that are configured as a loop. The neck and back of the animal are locations where achieving and contact between the shedding blade and the body of the animal may be difficult. It has also been recognized that storage, transport and display of traditional grooming tools incorporating shedding blades is inefficient as the shedding blade and handle may consume considerable space in a box or other packaging and take up considerable space in a retail product display.

It has been found that by allowing the handle of a grooming tool to fold or otherwise pivot among fixed positions relative to the shedding blade of the grooming tool (and vice versa) into a plurality of fixed angular positions, a more natural shedding or grooming angle can be achieved and the efficiency of each shedding stroke can be increased. Additionally, by allowing the handle to pivot relative to the shedding blade, a user can achieve a more comfortable grip while grooming an animal. Storage, transport and display of such a grooming tool may also be enhanced as the grooming tool can be folded into a more compact orientation. To this end, tools and methods are disclosed herein whereby a grooming tool includes a handle that can be pivoted relative to shedding blade.

In one aspect, a tool adapted for grooming an animal is provided that includes a handle with a gripping portion that is adapted to be gripped by a user, a shedding blade configured as a loop that is operatively attached to a distal end of the handle, and a pivot axis. The shedding blade includes at least a first serrated (e.g., toothed, jagged) edge and the gripping portion can be pivoted about the pivot axis in a rotational direction from at least a first fixed angular position to at least a second fixed angular position relative to the shedding blade. As a result, a user may advantageously select an angle between the gripping portion of the handle and the blade to provide for a more comfortable and effective position for the grooming tool. For example and in the situation where an animal is lying on its side, a user may be able to set an angle between the gripping portion and the blade to be approximately 90°. In this regard and when the blade is positioned against the animal's back and/or stomach, the gripping portion may generally protrude upward and thus generally perpendicularly from the animal. Such positioning of the gripping portion may allow the user to grasp the gripping portion as if the user was holding a ski pole which may increase the user's leverage relative to the grooming tool. Other positions and uses of the grooming tool are also contemplated.

The manner in which the gripping portion or shedding blade may be pivoted or otherwise positioned relative to the other of the gripping portion or shedding blade may be subject to a plurality of characterizations. In one characterization, the gripping portion may be pivoted about the pivot axis in the rotational direction to at least three fixed angular positions relative to the shedding blade. For instance, the gripping portion may snap, click and/or lock into and through a number of positions as it pivots around the pivot axis relative to the shedding blade in the rotational direction. Any appropriate folding or pivoting mechanism or member may be interconnected between the shedding blade and the gripping portion and/or form part of the shedding blade and/or gripping portion. In another characterization, the gripping portion may be pivoted about the pivot axis to a fixed angular position relative to the shedding blade whereby the gripping portion is disposed substantially within the loop. This positioning of the gripping portion may advantageously facilitate storage, formed by the shedding blade transport and retail display of the grooming tool as the grooming tool can be converted into a more compact orientation. Further characterizations contemplate that the gripping portion may be pivoted in the rotational direction by at least about 360°, 270°, or even other angles about the pivot axis to provide a user with increased adjustability of the grooming tool during a grooming operation.

In one embodiment, the first fixed angular position may define a first angle between the gripping portion and the shedding blade along the rotational direction that is less than about 180° and the second fixed angular position may define a second angle between the gripping portion and the shedding blade along the rotational direction that is greater than about 180° as measured along the same rotational direction as the first angle. Stated otherwise, the gripping portion may be pivoted along the rotational direction to positions both above and below an imaginary plane that extends through the shedding blade. This feature may advantageously allow a user to use both opposed sides of the shedding blade (e.g., first and second sets of teeth) at various angles.

The handle may also be subject to a number of characterizations. In one characterization, the gripping portion of the handle may be separable along a longitudinal axis of the gripping portion into at least a first grip member and a second grip member, whereby each of the first and second grip members can be individually grasped by the user during a grooming operation. This feature may allow a user to groom larger animals as a greater surface area can be covered with each stroke. In one variation, the first grip member may include a first engagement structure and the second grip member may include a second engagement that is removably attachable to the first engagement structure. For instance, the first engagement structure may include a rail and the second engagement structure may include a groove that is operable to slidably receive the rail. Such an arrangement may allow a user to quickly separate the first and second portions of the gripping portion to perform a grooming operation. However, other engagement structures are also contemplated. It should be appreciated that the handle may be constructed of any appropriate material(s) and in one arrangement, the gripping portion may include a soft rubber or rubber-like surface to enhance the user's grip on the gripping portion and increase user comfort.

The shedding blade may also be constructed of any appropriate material(s) such as various metals (e.g., stainless steel) and the like. In one arrangement, the shedding blade may include a second serrated edge opposed to the first serrated edge, and each of the first and second serrated edges may include a plurality of teeth. For instance, the plurality of teeth of the first serrated edge may be of a different size than the plurality of teeth of the second serrated edge. Having serrated edges of different sizes (e.g., according to tooth pitch, number of teeth per inch) may allow the same shedding blade to groom various types of animals with different types of fur and/or different portions of the same animal. Other edges and features may also be added to the shedding blade.

In any case, another arrangement envisions that the shedding blade may include a first end that is attached to a first attachment portion at a distal end of the handle and a second end that is attached to a second attachment portion at the distal end of the handle. Here, the first and second attachment portions may define a gap therebetween having a width that is greater than a width of the gripping portion. This arrangement may advantageously allow the gripping portion to be pivoted to a position such that it is encompassed by the blade to facilitate storage, transport and retail display of the tool. In one variation, the gripping portion may be joined to the first and second attachment portions along the pivot axis.

In another aspect, a grooming tool includes a shedding blade adapted for grooming an animal that is configured as a loop with opposed first and second serrated edges (e.g., a plurality of teeth), and a handle including a gripping portion that is adapted to be grasped by a user during a grooming operation. The handle also includes a pivoting mechanism that pivotally interconnects the shedding blade and the gripping portion. The pivoting mechanism may releasably fix the gripping portion into a plurality of different angular positions relative to the shedding blade. Accordingly, the pivoting mechanism may allow a user to find an optimal grooming angle between the shedding blade and the gripping portion. Additionally, the gripping portion may be pivoted in a rotational direction to at least a first fixed angular position whereby a first angle between the gripping portion and the shedding blade is less than about 180° and to a second fixed angular position in the rotational direction whereby a second angle between the gripping portion and the shedding blade is greater than about 180° as measured along the rotational direction. In one embodiment, the gripping portion may include first and second grip members that are separable along a longitudinal axis of the gripping portion each of which may be individually grasped by the user during a grooming operation. In another embodiment, each of the first and second serrated edges may have a plurality of teeth, each of which includes teeth of a different size.

In one variation, the pivoting or folding mechanism may include at least one pawl on one portion of the handle (e.g., the gripping portion) and a series of recesses on another portion of the handle. The pawl may be engageable with one of the series of recesses when the shedding blade is fixed into one of the plurality of positions. In another variation, the folding mechanism may include a ratchet assembly. Other arrangements are also contemplated.

Some embodiments of the present invention provide various methodologies for grooming one or more animals. In one aspect, a method for grooming an animal is provided using a grooming tool including a handle with a gripping portion that pivots about a pivot axis relative to a shedding blade, whereby the shedding blade is configured as a loop with at least a first serrated edge. The method includes the steps of first positioning of the gripping portion at a first fixed angular position relative to the shedding blade, first grooming the animal with the shedding blade by gripping the gripping portion and moving the shedding blade across fur of the animal, second positioning of the gripping portion at a second fixed angular position relative to the shedding blade that is different than the first fixed angular position, and second grooming the animal with the shedding blade positioned at the second fixed angular position by moving the shedding blade across the animal's fur. This method may allow a user to change an angle between the shedding blade and the gripping portion “on the fly” to allow the user to maintain an effective grooming angle.

In one embodiment, at least one of the first and second positioning steps may include engaging a release mechanism or member associated with the handle to release the gripping portion from its fixed position and pivoting the gripping portion relative to the shedding blade into the first or second fixed angular position. For instance, the release member may be positionable in at least first and second positions whereby the shedding blade is not pivotable relative to the gripping portion in the first position (e.g., is fixed) and is pivotable relative to the gripping portion in the second position. As another example, the positioning steps may include engaging a button that is slidable between the first and second positions to fix and release the gripping portion. Additionally, the release member may include a biasing member (e.g., compression spring, torsion spring) that is operable to urge the button into the first position.

Another embodiment envisions that the gripping portion may include first and second grip members on opposite sides of a longitudinal axis of the gripping portion. Here, the method may include (e.g., before at least one of the first and second grooming steps) separating the first grip member from the second grip member to configured the shedding blade as an elongated strip, and individually grasping each of the first and second grip members and moving the shedding blade across the animal's fur. For instance, the separating step may include sliding the first grip member relative to the second grip member. In one variation, each of the first and second grip members may include a release member that allows the respective grip member to be pivoted relative to the shedding blade.

In other embodiments, the shedding blade may include a second edge opposed to the first serrated edge or additional serrated edges, the gripping portion may be pivoted in a rotational direction to fixed angular positions both less and greater than 180° relative to the shedding blade as measured along the rotational direction, the method may include third positioning the gripping portion at a third fixed angular position relative to the shedding blade whereby the gripping portion is at least substantially encompassed by the loop, and/or the method may include second positioning the gripping portion to be at least substantially encompassed by the loop.

The present invention is directed to the embodiments and aspects that are summarized above, alone or in any combination, as well as additional embodiments and aspects and combinations thereof that will be apparent from the following description of the invention.

### BRIEF DESCRIPTION OF THE DRAWINGS

FIG. 1 is a perspective view of one embodiment of a grooming tool according to the present invention whereby the gripping portion of the handle is positioned at a first fixed angular position relative to the shedding blade.

FIG. 2 is a perspective view of the grooming tool of FIG. 1 with the gripping portion being positioned at a second fixed angular position relative to the shedding blade.

FIG. 3 is a perspective view of the grooming tool of FIG. 1 with the gripping portion being positioned at a third fixed angular position relative to the shedding blade.

FIG. 4 is a perspective view of the grooming tool of FIG. 1 with the gripping portion being positioned at a fourth fixed angular position relative to the shedding blade.

FIG. 5 is a perspective view of the grooming tool of FIG. 1 with the gripping portion being positioned at a fifth fixed angular position relative to the shedding blade.

FIGS. 6a-6d illustrate side views of the grooming tool of FIG. 1 at various fixed angular positions as the gripping portion is pivoted about a pivot axis in a rotational direction.

FIG. 7 is a perspective view of the handle of FIG. 1 illustrating first and second grip members of the gripping portion being separated from each other.

### DETAILED DESCRIPTION OF THE DRAWINGS

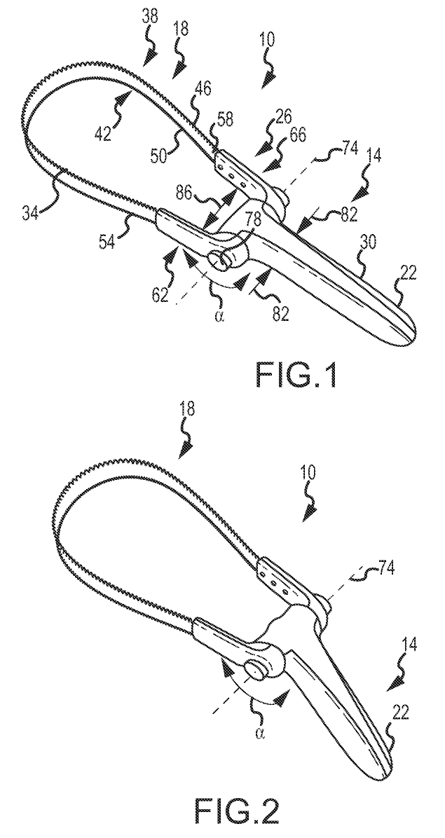

Turning now to the figures, FIG. 1 illustrates one embodiment of a tool 10 for grooming an animal such as a dog, horse and the like. Broadly, the tool 10 includes a handle 14 and a shedding blade 18, whereby at least a portion of the handle 14 may be pivotable (e.g., foldable) relative to at least a portion of the shedding blade 18 and vice versa into a plurality of fixed angular positions. In this regard, an animal owner or other user may be able to achieve an effective and comfortable orientation of the tool 10 during a grooming operation.

The handle 14 may be in the form of a housing (e.g., constructed of acrylonitrile butadiene styrene or other plastics or metals) with a gripping portion 22 and a distal end 26 for receipt of and/or interconnection to the shedding blade 18 as will be described more fully below. The gripping portion 22 may be of any appropriate ergonomic shape(s) and dimensions that facilitate gripping of the gripping portion 22 and use of the tool 10 by a user. As shown, the gripping portion 22 may also include one or more gripping enhancement (e.g., non-slip) features 30 such as one or more portions or strips of rubber or other similar materials (e.g., thermoplastic rubber). Additionally or alternatively, the gripping portion 22 may include protrusions, cutouts, finger grips or other features to facilitate gripping of the gripping portion 22. It will also be appreciated that the handle may be manufactured using any appropriate process (e.g., injection molding).

The shedding blade 18 may include an elongated strip member 34 of any appropriate material (e.g., stainless steel) that may be configured as a loop or other appropriate shape. The elongated strip member 34 may include first and second opposed edges 38, 42, and the first and second edges 38, 42 may comprise first and/or second opposed sets of teeth 46, 50. In this regard, the first and second edges 38, 42 may be considered first and second “serrated edges”. With additional reference now to FIG. 7, the first and second sets of teeth 46, 50 may be of different sizes. As shown, the first set of teeth 46 includes larger individual teeth and fewer teeth per inch while the second set of teeth 50 includes smaller individual teeth and more teeth per inch. As such, the tool 10 may be used to groom various types of animals with different types of fur and/or different portions of the same animal. Other sizes and arrangements of teeth or other features on the elongated strip member 34 are also envisioned.

Returning to FIG. 1, the shedding blade 18 may also include first and second ends 54, 58 that may be appropriately received by and/or interconnected to the distal end 26 of the handle 14. For instance, the distal end 26 may include first and second attachment projections or portions 62, 66 operative to receive and/or interconnect to the first and second ends 54, 58. The first and second attachment portions 62, 66 may be joined to the gripping portion 22 along a pivot axis 74. With reference again to FIG. 7, an upper portion of each of the first and second attachment portions 62, 66 may include an aperture therein (not labeled) sized to respectively receive the first and second ends 54, 58 of the shedding blade. Additionally, one or more fasteners 70 (e.g., screws, bolts, rivets) may be received through bores or apertures in portions of the first and second attachment portions 62, 66 and ends 54, 58 to at least respectively secure the first and second ends 54, 58 to the first and second attachment portions 62, 66 and thus the shedding blade 18 to the handle 14. In this regard, each of the first and second ends 54, 58 may be at least substantially immovable and rigid relative to the first and second attachment portions 62, 66, respectively, and thus may move (e.g., pivot) with the first and second projections as a single unit. Other manners of removably interconnecting the first and second ends 54, 58 to the first and second attachment portions 62, 66 are also envisioned (e.g., ratcheting mechanisms).

As discussed above, at least a portion of the handle 14 may be pivotable (e.g., foldable) relative to at least a portion of the shedding blade 18. As shown, the gripping portion 14 may be pivotable relative or in relation to both the shedding blade 18 and the distal end 26 about a pivot axis 74. To this end, each of the first and second attachment portions 62, 66 may be pivotally interconnected to the gripping portion 22 about the pivot axis 74 by any appropriate pivoting mechanism (e.g., pin(s)) such that the gripping portion 22 may be pivoted to a plurality of fixed angular positions (e.g., two, three, or more) relative to the shedding blade 18. For instance, the gripping portion 22 may snap, click and/or lock into and through a plurality of positions (described more fully below) as it pivots about the pivot axis 74 relative to the shedding blade 18 and the distal end 26. In FIG. 1, the gripping portion 22 is illustrated as being at an angle of about 180° relative to the shedding blade 18.

The tool 10 may also include one or more release mechanisms or buttons 78 that may allow the gripping portion 22 to pivot relative to the shedding blade 18 when engaged (e.g., pressed) or otherwise manipulated. As shown, the tool 10 may include a pair of buttons 78 protruding from the first and second attachment portions 62, 66. In use, an operator may press or slide each of the buttons 78 inwards (e.g., towards the upper portion of the gripping portion 22) into a first position and pivot the gripping portion 22 about the pivot axis 74 relative to the shedding blade 18. When the user has at least approximately reached a desired fixed angular position of the gripping portion 22 relative to the shedding blade 18, the user may release (e.g., let go of) the buttons 78 at which time any appropriate biasing mechanism (e.g., compression or torsion spring, not shown) mounted between the first and second upper portions of the gripping portion 22 and the buttons 78 may urge or slide the buttons 78 outward (e.g., in a direction away from the tool 10) into a second position. Thereafter, if the gripping portion 22 is not already locked into the desired locked or fixed angular position, the user may again attempt to pivot the gripping portion 22 relative to the shedding blade 18 until the gripping portion clicks or locks into the next closest position.

It will be appreciated that the buttons 78 may interact with the pivoting mechanism in any appropriate manner to selectively allow and disallow pivoting between the gripping portion 22 and the shedding blade 18. As an example, one or more pawls on one of the first and second attachment portions 62, 66 or the upper portion of the gripping portion 22 may selectively interact with a circular series of recesses formed on the other of the first and second attachment portions 62, 66 or the upper portion of the gripping portion 22 by way of the buttons 78 to lock the gripping portion 22 in a desired fixed angular position relative to the shedding blade 18. Other arrangements for selectively allowing pivoting are also envisioned.

With continued reference to FIG. 1, it can be seen that a width 82 of an end of the gripping portion 22 proximate to the attachment portions 62, 66 may be less than a gap defining a width 86 between the first and second attachment portions 62, 66. Stated differently, the width 86 between the first and second attachment portions 62, 66 may be greater than the width 82 of a portion of the gripping portion 22. As a result, the gripping portion 22 may be pivoted to a fixed angular position such that the gripping portion 22 is received within or encompassed by the elongated member 34 (e.g., see FIG. 5). Of course, the entire gripping portion 22 need not necessarily be of a width less than that between the first and second attachment portions 62, 66 in order for the gripping portion 22 to be received within the elongated member 34. Referring to FIG. 5 and although not illustrated, a distal end of the gripping portion 22 may have a width greater than that between the first and second attachment portions 62, 66 so long as the width of this portion is less than a width between first and second sides of the elongated member 34. As discussed above, allowing the gripping portion 22 to be pivoted to a position whereby it is received within the looped elongated member 34 facilitates transport, storage and retail display of the tool 10 as its volume may be reduced.

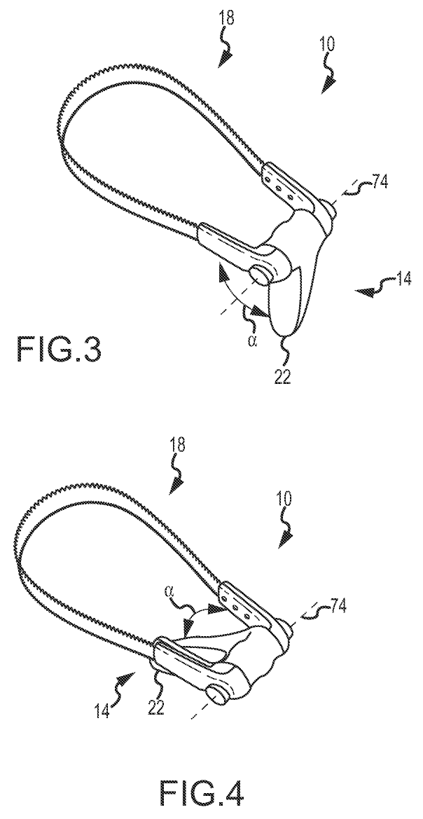

With reference now to FIGS. 1-5, various locked or fixed angular positions of the gripping portion 22 relative to the shedding blade 18 are illustrated. As shown in FIG. 1, an angle α between the gripping portion 22 and the shedding blade 18 is 180°. As seen in FIG. 2, the gripping portion 22 has been pivoted about the pivot axis 74 (e.g., after a user has depressed the buttons 78) in a rotational direction so that the angle α is for instance 135°. For example, a user may find that this angle facilitates the grooming of one or more portions of an animal (e.g., neck, stomach) or a different type of animal. With continued reference to FIGS. 3-5, the gripping portion 22 has been further pivoted about the pivot axis 74 to other fixed angular positions until the angle α equals 0° or 360° in FIG. 5 at which point the gripping portion 22 is at a fixed angular position whereby it is substantially disposed or received within the elongated member 34. Although not illustrated, the gripping portion 22 may be further pivoted along the same rotational direction to additional angles between 360° and 180° relative to the shedding blade 18. In this regard, the gripping portion 22 may be pivoted by at least about 360° around or relative to the pivot axis 74. In other embodiments, the gripping portion 22 may be pivoted by at least about 270° around or relative to the pivot axis 74. Additionally, while FIGS. 1-5 illustrate five locked or fixed angular positions between 180° and 0°, it is envisioned that more or fewer locked or fixed positions could be included. In one arrangement, the gripping portion 22 could be pivoted about the pivot axis 74 relative to the shedding blade 18 along the rotational direction to infinite fixed positions (e.g., with the use of a compression screw). It should also be appreciated that the gripping portion 22 can be pivoted along a rotational direction (e.g., clockwise or counterclockwise) to fixed angular positions that are greater than and less than 180° relative to the shedding blade 18. For instance, a first fixed angular position may define a first angle between the gripping portion 22 and the shedding blade 18 along a rotational direction that is less than about 180°, and a second fixed angular position may define a second angle between the gripping portion 22 and the shedding blade 18 along the same rotational direction that is greater than about 180°. This arrangement may allow use of the first and second sets of teeth 46, 50 on the shedding blade 18 among other advantages.

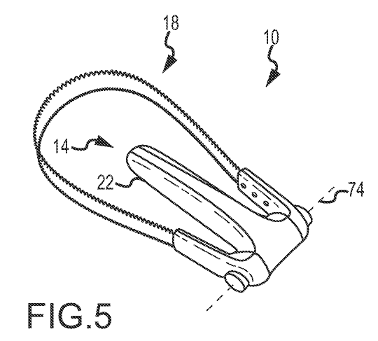

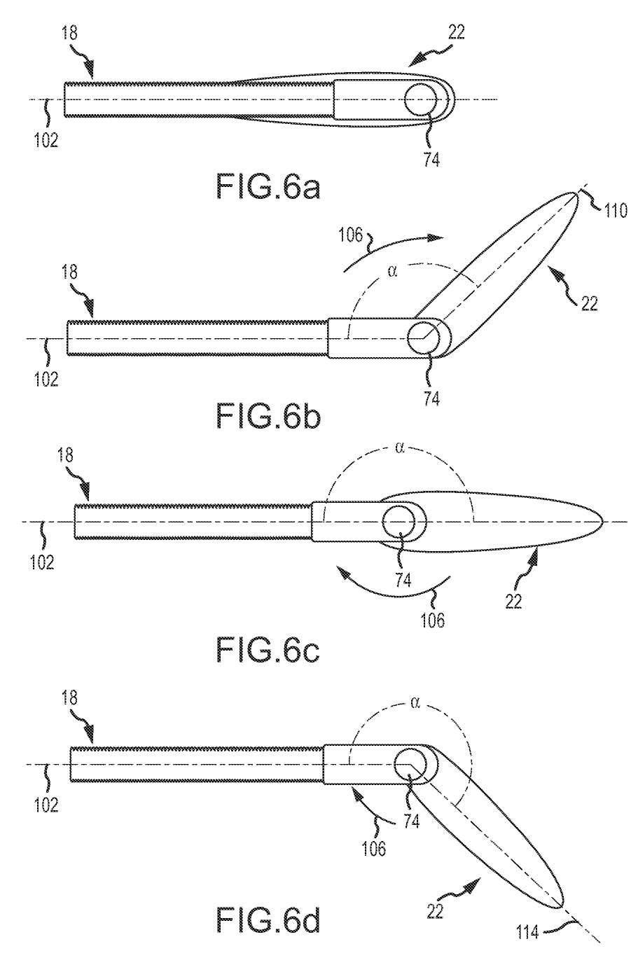

With reference now to FIGS. 6a-6d, side views of the grooming tool of FIG. 1 are illustrated with the gripping portion 22 being disposed at various fixed angular positions relative to the shedding blade 18. As seen in FIG. 6a, the gripping portion 22 is disposed at a first fixed angular position within the shedding blade 18 and this may be considered an angle α of about 0° (not labeled in FIG. 6a) between the gripping portion 22 and the shedding blade 18. Additionally, each of the shedding blade 18 and gripping portion 22 may be generally disposed in a first plane 102 when the angle α is about 0°. Moving now to FIG. 6b, the gripping portion 22 has been pivoted about the pivot axis 74 in a rotational direction 106 to a second fixed angular position relative to the shedding blade 18 whereby the angle α is about 135°. It can also be seen now that while the shedding blade 18 may generally remain in the first plane 102, the gripping portion 22 may now generally reside in a second plane 110.

In FIG. 6c, the gripping portion 22 has been pivoted about the pivot axis 74 in the rotational direction 106 to a third fixed angular position relative to the shedding blade 18 whereby the angle α is about 180°. It can also be seen now that both the shedding blade 18 and the gripping portion 22 again generally reside in the first plane 102. FIG. 6d illustrates the gripping portion 22 being pivoted about the pivot axis 74 in the rotational direction 106 to a fourth fixed angular position relative to the shedding blade 18 whereby the angle α is about 225°. It can also be seen now that while the shedding blade 18 may generally remain in the first plane 102, the gripping portion 22 may now generally reside in a third plane 114.

It should be appreciated that the above used “first fixed angular position,” “second fixed angular position,” etc. are merely arbitrary labels and that any of the fixed angular positions could be the “first fixed angular position,” “second fixed angular position,” etc. For instance, FIGS. 6b and 6d illustrate how a first fixed angular position may define an angle α between the gripping portion 22 and the shedding blade 18 along the rotational direction 106 that is less than about 180° (e.g., as shown in FIG. 6b) and a second fixed angular position may define an angle α between the gripping portion 22 and the shedding blade 18 along the rotational direction 106 that is greater than about 180° (e.g., as shown in FIG. 6d). Also, while one rotational direction (e.g., rotational direction 106) has been discussed and illustrated herein, this disclosure is equally applicable to another (e.g., opposite) rotational direction of the gripping portion 22 relative to the shedding blade 18.

Referring now to FIG. 7, a close-up perspective view of the handle 14 is illustrated. As shown, the gripping portion 22 may be separable along a longitudinal axis 98 of the gripping portion 22 into at least first and second grip members 90, 94. Additionally, the first and second grip members 90, 94 may include respective first and second engagement structures (not labeled) for removably interconnecting the first and second grip members 90, 94. For instance, the first and second grip members 90, 94 may be slidably interconnected in any appropriate manner (e.g., a rail operable to slidably receive a groove). Further, a locking or retaining structure (e.g., detent and opening, not shown) may be included between the first and second grip members 90, 94 to initially limit the first and second grip members 90, 94 from sliding relative to each other when the first and second grip members 90, 94 are in the position shown in FIGS. 1-5.

When a user attempts to slide the first and second grip members 90, 94 relative to each other with enough force to overcome the force created by the detent, the first and second grip members 90, 94 may be slid or otherwise move relative to each other to at least the position shown in FIG. 7. If the user continues sliding the first and second grip members 90, 94 relative to each other, the first and second grip members 90, 94 may eventually become separated. At this point, each of the first and second grip members 90, 94 may effectively function as a separate gripping portion that may be individually grasped by a user during a grooming operation. Allowing the first and second grip members 90, 94 to be individually grasped spreads out the elongated member 34 and increases the surface area of an animal that may be groomed. As such, this orientation may be advantageous during grooming operations involving larger animals.

As can be seen in FIG. 7, the upper portions of each of the first and second grip members 90, 94 of the gripping portion 22 remain pivotally interconnected to the first and second attachment portions 62, 66 even after the first and second grip members 90, 94 have been partially or even fully separated. That is, a separate pivoting mechanism may be interposed between the first grip member 90 and first attachment portion 62, and also between the second grip member 94 and second attachment portion 66. As such, any desired angle between the gripping portion 22 and the shedding blade 18 that was set before the first and second grip members 90, 94 were separated may remain even after the first and second grip members 90, 94 are separated. Furthermore, one or more of the buttons 78 may be depressed even after the first and second grip members 90, 94 have been separated to further adjust the first and second grip members 90, 94 relative to the shedding blade 18 to facilitate a grooming operation. While the first and second grip members 90, 94 have been shown as being slidably interconnected, in other embodiments the first and second grip members 90, 94 may be interconnected by way of snaps, bolts, fasteners and/or the like.

The grooming tool 10 disclosed herein may be advantageously used to comfortably and effective groom an animal in any number of manners. For instance, the gripping portion 22 may be placed or positioned at a first fixed angular position relative to the shedding blade 18 and then the animal may be groomed with the shedding blade by gripping the gripping portion 22 and moving the shedding blade 18 across the animal's fur. However, upon determining that the first fixed angular position is inadequate or otherwise undesirable, the user may appropriately position the gripping portion 22 at a different or second fixed angular position relative to the shedding blade 18 (e.g., engaging the release mechanism/buttons 78 and pivoting the gripping portion 22 relative to the shedding blade 18) and then groom the animal with the shedding blade 18 positioned at the second fixed angular position by moving the shedding blade 18 across the animal's fur. It should be appreciated that rotating the gripping portion relative to the shedding blade also facilitates use of the first and second sets of teeth 46, 50.

Additionally, the gripping portion 22 may be separated into the first and second grip members 90, 94 and then the grip members 90, 94 may be grasped to create a larger grooming swath of the elongated member 34. For instance, this feature of the grooming tool 10 may facilitate the grooming of larger animals. When the user is finished grooming, the gripping portion 22 may be positioned at a third fixed angular position relative to the shedding blade 18 whereby the gripping portion 22 is at least substantially encompassed by the loop of the elongated member 34 (i.e., the gripping portion 22 may be pivoted into the loop) and the tool 10 may be stored. Other manners of using the grooming tool 10 are also envisioned.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A tool adapted for grooming an animal, comprising:
a handle comprising a gripping portion that is adapted to be gripped by a user;
a shedding blade configured as a loop that is operatively attached to a distal end of the handle, wherein the shedding blade includes at least a first serrated edge; and
a pivot axis, wherein the gripping portion may be pivoted about the pivot axis in a rotational direction from at least a first fixed angular position to at least a second fixed angular position relative to the shedding blade.

2. The tool of claim 1, wherein the gripping portion may be pivoted about the pivot axis in the rotational direction to at least three fixed angular positions relative to the shedding blade.

3. The tool of claim 1, wherein the gripping portion may be pivoted about the pivot axis in the rotational direction to a fixed angular position relative to the shedding blade whereby the gripping portion is disposed substantially within the loop.

4. The tool of claim 1, wherein the at least first fixed angular position defines a first angle between the gripping portion and the shedding blade along the rotational direction that is less than about 180° and the at least second fixed angular position defines a second angle between the gripping portion and the shedding blade along the rotational direction that is greater than about 180°.

5. The tool of claim 4, wherein the shedding blade comprises a second serrated edge opposed to the first serrated edge, wherein each of the first and second serrated edges comprises a plurality of teeth.

6. The tool of claim 1, wherein the gripping portion may be pivoted in the rotational direction by at least about 360° about the pivot axis.

7. The tool of claim 1, wherein the gripping portion may be pivoted in the rotational direction by at least about 270° about the pivot axis.

8. The tool of claim 1, wherein the shedding blade comprises a first end that is attached to a first attachment portion at a distal end of the handle and a second end that is attached to a second attachment portion at the distal end of the handle, wherein the first and second attachment portions define a gap therebetween having a width that is greater than a width of the gripping portion.

9. The tool of claim 8, wherein the gripping portion is joined to the first and second attachment portions along the pivot axis.

10. The tool of claim 1, wherein the gripping portion is separable along a longitudinal axis of the gripping portion into at least a first grip member and a second grip member, whereby each of the first and second grip members can be individually grasped by the user during a grooming operation.

11. The tool of claim 10, wherein the first grip member comprises a first engagement structure and the second grip member comprises a second engagement structure that is removably attachable to the first engagement structure.

12. The tool of claim 1, wherein the shedding blade comprises a second serrated edge opposed to the first serrated edge, wherein each of the first and second serrated edges comprises a plurality of teeth.

13. The tool of claim 12, wherein the plurality of teeth of the first serrated edge are of a different size than the plurality of teeth of the second serrated edge.

14. A grooming tool, comprising:
a shedding blade adapted for grooming an animal, the shedding blade being configured as a loop and having opposed first and second serrated edges;
a handle comprising:
a gripping portion that is adapted to be grasped by a user during a grooming operation; and
a pivoting mechanism that pivotally interconnects the shedding blade and the gripping portion, wherein the pivoting mechanism is adapted to releasably fix the gripping portion into a plurality of different angular positions relative to the shedding blade, and wherein the gripping portion may be pivoted in a rotational direction to at least a first fixed angular position whereby a first angle between the gripping portion and the shedding blade is less than about 180° and to a second fixed angular position in the rotational direction whereby a second angle between the gripping portion and the shedding blade is greater than about 180° as measured in the rotational direction.

15. The grooming tool of claim 14, wherein the gripping portion comprises first and second grip members that are separable along a longitudinal axis of the gripping portion, whereby each of the first and second grip members can be individually grasped by the user during a grooming operation.

16. The grooming tool of claim 14, wherein each of the first and second serrated edges comprises a plurality of teeth, wherein the plurality of teeth of the first serrated edge are of a different size than the plurality of teeth of the second serrated edge.

17. A method for grooming an animal using a grooming tool including a handle with a gripping portion that pivots about a pivot axis relative to a shedding blade, the shedding blade configured as a loop with at least a first serrated edge, the method comprising the steps of:
first positioning of the gripping portion at a first fixed angular position relative to the shedding blade;
first grooming the animal with the shedding blade by gripping the gripping portion and moving the shedding blade across fur of the animal;
second positioning of the gripping portion at a second fixed angular position relative to the shedding blade that is different than the first fixed angular position; and
second grooming the animal with the shedding blade positioned at the second fixed angular position by moving the shedding blade across the fur of the animal.

18. The method of claim 17, wherein at least one of the first and second positioning steps comprises:
engaging a release mechanism associated with the handle; and
pivoting the gripping portion relative to the shedding blade into the first or second fixed angular position.

19. The method of claim 17, wherein the gripping portion comprises first and second grip members on opposite sides of a longitudinal axis of the gripping portion, wherein the method further comprises the steps of:
separating the first grip member from the second grip member to configure the shedding blade as an elongate strip; and
individually grasping each of the first and second grip members and moving the shedding blade across the fur of the animal.

20. The method of claim 17, wherein the shedding blade comprises a second serrated edge opposed to the first serrated edge.

21. The method of claim 20, wherein the gripping portion may be pivoted in a rotational direction to fixed angular positions both less than and greater than about 180° relative to the shedding blade as measured along the rotational direction.
